(19) United States
(12) Patent Application Publication
(10) Pub. No.: US 2011/0153714 A1
(43) Pub. Date: Jun. 23, 2011

(54) SECURE REMOTE WEB POPUP

(76) Inventor: Robert Houben, Vancouver (CA)

(21) Appl. No.: 12/966,416

(22) Filed: Dec. 13, 2010

Related U.S. Application Data
(60) Provisional application No. 61/287,693, filed on Dec. 17, 2009.
(60) Provisional application No. 61/288,164, filed on Dec. 18, 2009.

(51) Int. Cl. G06F 15/16

(52) U.S. Cl. 709/202; 709/227

(57) ABSTRACT

A system and a method are provided to initiate a popup web browser window without the need for manual installation or configuration of components on a client workstation, to bypass the apparent limitations of a web browser and simultaneously provide security and protection that the web browser's security would provide, if not bypassed. The system and method are configured and arranged to prevent malicious third parties from invoking a flood of popped-up web browser sessions resulting in a Denial of Service (DOS) attack.

### CROSS-REFERENCE TO RELATED APPLICATIONS

This utility patent application claims the benefit, under 35 U.S.C. §119(e), of the U.S. provisional patent application entitled “Secure Remote Web Popup” by the same inventors, filed Dec. 17, 2009, Ser. No. 61/287,693, and the U.S. provisional patent entitled “Secure Remote Web Popup” by the same inventors, filed Dec. 18, 2009, Ser. No. 61/288,164, both of which are incorporated herein in their entirety by reference as if set forth in full below.

### COPYRIGHT NOTICE

A portion of the disclosure of this patent application contains material that is subject to copyright protection. The copyright owner has no objection to the facsimile reproduction by anyone of the patent application or the patent disclosure, as it appears in the Patent and Trademark Office patent file or records, but otherwise reserves all copyright rights whatsoever.

### BACKGROUND OF THE INVENTION

As the Internet and the World Wide Web have increased their adoption, more and more applications are being hosted in web browsers. Some of the benefits of this approach include automatic installation from a web page, ubiquitous usability, and just the fact that most users are already comfortable working with a web page.

Rich client applications, such as client/server applications, have typically allowed control over a user's system in ways that a web browser generally does not permit. However, large scale deployment of rich client applications is complex, time consuming, and expensive, which makes web browser based applications a more attractive option. Web browsers, however, expose their users to a number of serious risks such as viruses and worms. Therefore, web browser vendors have implemented security restrictions to the activities that can be performed through a web browser session. These restrictions prevent client systems from sending a server enough information to enable the server to initiate a popup web browser window. Most users and even information technology departments are unsophisticated from a security point of view, and are uncomfortable with making changes to these web browser restrictions. As can be appreciated, such users typically find that a solution which requires customization of web browser security is unacceptable.

Many customers go to great lengths to find a simple, reliable, workable solution that can operate in a web browser's sandbox environment, and that would allow them to solve the problem of how to initiate a popup web browser window on a client system, without relaxing security restrictions on the web browser, or without manually installing or configuring a rich client application on each client system. In solving this problem, careful attention should be paid to avoid exposing a client system to Denial Of Service (“DOS”) attacks or other security risks. Despite the efforts of several vendors in the computer industry, users have been unable to find an acceptable solution.

In the context of a web browser's sandbox environment, these problems are difficult to solve for various reasons. For example, web browser pages are stateless and are thus disconnected from the server. Therefore there is no connection which can be used to send information to the client. Furthermore, the web browser's sandbox environment would not allow a user to:

1) Examine the contents of a system's hard drive or to load Java classes from said system's hard drive;

2) Launch a popup web browser window to a machine other than the machine that the initial web page resides upon; or

3) Discover routable networking information, such as Internet protocol (“IP”) addresses and machine names.

As a result of these problems, there is a continuing need for a system and method that allows a user to transmit uniquely identifiable information to a server that would enable it to open a connection back to a user's workstation. In order to do so, a method of installing components on the user's workstation is desired. Ideally, installation of components on the user's workstation should occur automatically, account for different versions of the components, and send information to the server which allows the server to locate and communicate with the user's workstation.

Preferably, a system should be designed to overcome several problems which arise, including, but not limited to, the following:

1) A component on a client system typically determines if all necessary components are already installed by checking the hard disk or loading a class. However, at times the problem arises where an installed component is unable to make such a determination because it is unable to check the hard disk or load a class.

2) The system is unable to check the version of an installed component.

3) The system is unable to communicate with a host system. Though an applet could open a socket, it could not transmit a user's IP address to a host system, rendering the host system unable to open a connection back to the user.

4) The system opens a socket on the client machine, thereby bypassing the security in a web browser's sandbox environment. In bypassing the security, the system needs a way to prevent malicious third parties from invoking a flood of popped up web browser sessions which results in a DOS attack.

### SUMMARY OF THE INVENTION

In one embodiment, a system and method are configured to allow a user to run programs and access data on a server through the user's popup web browser window. This embodiment allows a system to bypass the apparent limitations of the web browser, while still providing the security and protection that the web browser's security is expected provide, if not bypassed.

In another embodiment, a system and method are configured to initiate a popup web browser window without the need for manual installation or configuration of components on a client workstation.

In yet another embodiment, the system and method are also configured to bypass the apparent limitations of a web browser, while still providing security and protection from malicious attacks. The system and method are further configured to prevent malicious third parties from invoking a flood of popped up web browser sessions resulting in a DOS attack, thus providing a secure, reliable way for a server to initiate a popup web browser window on a client's workstation.

In still another embodiment, the system and method are configured to automatically determine whether components are installed, or whether the versions of those components are current.

In yet another embodiment, a system for accessing a host computer system through a web server comprises a means for utilizing a web browser in a client system to access an Initial Login Page on a host computer system, a means for generating a list of MAC addresses present on the client system, means for transmitting the list of MAC addresses and other information gathered from the client system to the host computer system, a means for opening a connection from the host computer system to the client system by utilizing the information transmitted to the host computer system, a means for executing an agent listener on the client system, means for connecting the host computer system to the client system, a means for transmitting information from the client system to the host computer system, a means for transmitting commands from the host computer system to the agent listener, and a means for utilizing the agent listener to open a new web browser window on the client system. The system further includes a means for verifying whether a combination of the list of MAC addresses and a User ID is already stored on the host computer system, a means for redirecting the client system to an Installer Download Page if the combination of the list of MAC addresses and the User ID is not already stored on the host computer system, and a means for installing an agent listener on the client system. In another embodiment, the system further includes a means for verifying that the version number for an agent listener is the same as a current version number, a means for redirecting the client system to an Installer Download Page if the version number for the agent listener is not the same as the current version number, and a means for installing an updated agent listener on the client system. In a further embodiment, the system further includes a means for redirecting the client system to an Installer Download Page if the socket to the client system cannot be opened, and a means for installing an agent listener on the client system. The system further includes a means for transmitting commands containing a formatted URL from the host computer system to the agent listener.

Other systems and/or methods according to embodiments may be or become apparent to one with skill in the art upon review of the following drawings, and further descriptions.

### BRIEF DESCRIPTION OF THE DRAWING

To the accomplishment of the above and related objects, the invention may be embodied in the form illustrated in the accompanying drawings, attention being called to the fact, however, that the drawings are illustrative only, and that changes may be made in the specific construction and method illustrated:

FIG. 1 illustrates a schematic network diagram of a system 100 (i.e. network architecture) in accordance with one embodiment;

FIG. 2 illustrates a first flow diagram 200 illustrating a series of method steps to redirect an agent from an initial login page to a new web browser page; and

FIG. 3 is a second flow diagram 300 illustrating a sequence of method steps that an IBM i system 115 uses to communicate with an agent listener 134.

### DETAILED DESCRIPTION OF THE INVENTION

Embodiments described herein relate to a system and method configured to initiate a popup web browser window without the need for manual installation or configuration of components on a client workstation, bypass the apparent limitations of a web browser, and provide security and protection against the malicious attacks that the web browser's security would otherwise prevent. Methods and structures of the system are not limited to the specific embodiments described herein. Any embodiment described herein as “exemplary” is not necessarily to be construed as preferred or advantageous over other embodiments.

In one embodiment, a system consists of an IBM i (formerly known as AS400) system with a legacy application compatible with the RPG programming language (“RPG program”), where the system is capable of invoking a popup web browser window on a remote user's system. Those versed in the art will understand that many of the details listed are details of the prototype implementation, and not limitations of the method.

The embodiment is configured to perform the following steps: 1) a client, using a web browser, logs on to a session that can access a legacy host system through a web server; 2) the legacy host system determines the need to notify the client to perform specific actions and then proceeds to make such a notification; and 3) the client launches a new web browser window without losing their current web browser location and focus.

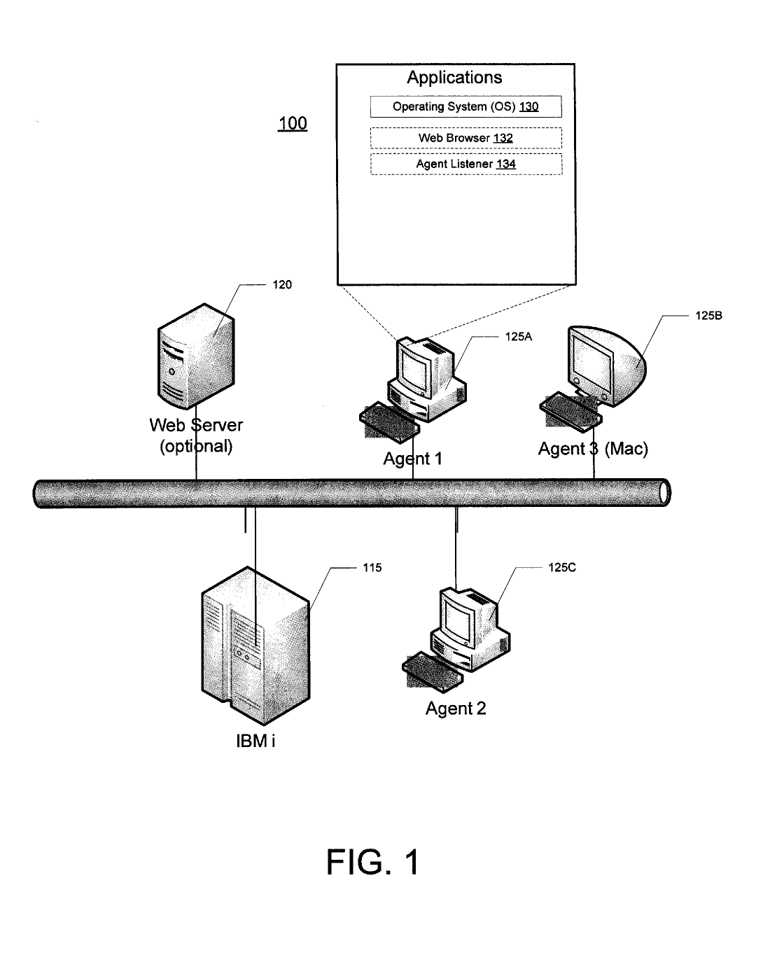

FIG. 1 is a schematic network diagram of a system (i.e. network architecture) 100 in accordance with one embodiment. As can be appreciated, system 100 is exemplary as a reference for illustrative purposes and may be varied. System 100 includes at least one IBM i system 115 and at least one web server 120 that has access to data and programs on at least one IBM i system 115. At least one web server 120 serves the new web browser-based application, which may be integrated with RPG programs, DB2/400 libraries and data files. System 100 further includes a plurality of agent computers 125A, 125B and 125C. Agent computers 125A, 125B or 125C may include thin clients or thin computers, in which case, the actual computing resources may be multiple sessions running on a single server through either a Citrix or Terminal Server environment. Agent computers 125A, 125B or 125C may initially interact with IBM i system 115 through a web browser, and may be directed to a page where agent computers 125A, 125B or 125C may need to allow an installer to run. Agent computers 125A, 125B and 125C include an operating system 130 and a plurality of software programs (not shown) for performing many of the functions described herein. For example, agent computers 125A, 125B and 125C may include a web browser 132 and optionally an agent listener 134.

IBM i system 115 may interact with agent computers 125A, 125B and 125C through responses to web page requests, through a link from IBM i system 115 to agent listener 134 which is installed on agent computers 125A, 125B or 125C, or in the agent's session in the Citrix or Terminal Server environment.

Under normal circumstances an agent may only need to install agent listener 134 once. Thereafter installation of agent listener 134 may need to be done if upgrades are available for agent listener 134, or if a change in configuration for agent computers 125A, 125B or 125C takes place.

System 100 may include a web server 120, which may or may not be on IBM i system 115. Web browsers enforce significant restrictions on what an applet can do when downloaded from any place other than the local machine. Therefore another embodiment of system 100 allows IBM i system 115 to reliably identify criteria to communicate with agent computers 125A, 125B, or 125C without manually applying changes to the computing environment for agent computers 125A, 125B, or 125C in order to support communications.

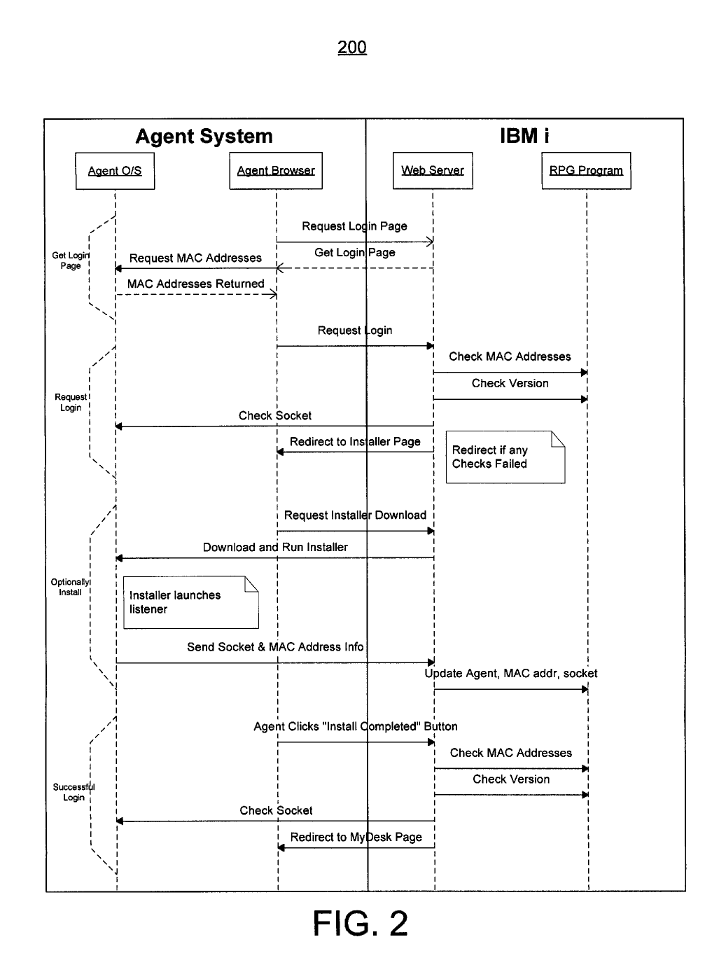

FIG. 2 illustrates a first flow diagram 200 demonstrating a series of method steps to redirect an agent from an initial login page to a new web browser page.

In one embodiment, on the left hand side of first flow diagram 200, a plurality of tabs are depicted, which are labeled as Get Login Page, Request Login, Optionally Install, and Successful Login. Each tab includes and illustrates a sequence of steps to perform the labeled operation. It should be noted that in various configurations below, the flow diagram steps are performed in the depicted order or these steps or portions thereof may be performed contemporaneously, in parallel, or in a different order.

As illustrated under the Get Login Page tab, an agent via agent computers 125A, 125B or 125C begins by opening a shortcut that launches a web browser 132 to a Login Page on web server 120, where web server 120 is hosted on IBM system 115. A Java applet on the Login Page also updates a hidden web browser control with the Media Access Control (“MAC”) addresses that are potentially relevant on agent computers 125A, 125B or 125C. There can be an arbitrary number of MAC addresses which are sorted, separated by commas, and stored in a single hidden form text control.

The agent, via agent computers 125A, 125B or 125C, enters a User ID and password and submits the form to the Login Submitted page on web server 120.

As illustrated under the Request Login tab, when web server 120 receives a Login processing request, web server 120 uses the combination of MAC addresses and the User ID (“ID Combination”) to lookup in a special file whether necessary components were previously installed on agent computers 125A, 125B or 125C (hereinafter referred to as a “first check”). In a first check, an RPG program may take MAC addresses and User ID. IBM i system 115 may return a Hostname or IP Address, Port Number, and Installed Version to the web layer.

As illustrated under the Optionally Install tab, during the first check, if the ID Combination is not registered as previously installed on IBM i system 115, the agent is redirected to an Installer Download Page where the agent has an option to install the components or return to the Login Page.

As illustrated under the Successful Login tab, if the ID Combination is registered as previously installed, web server 120 further checks to ensure that the installed version is the current version. If a discrepancy in versions is determined, the agent is again redirected to the Installer Download Page.

If the ID Combination is registered as previously installed and the current version is installed, then web server 120 attempts to open a socket to the indicated address/port combination that agent listener 134 was configured to access, on that machine/user combination for agent computers 125A, 125B or 125C.

If the socket cannot be opened, the agent is redirected to the Installer Download Page. The agent may be redirected because 1) agent computers 125A, 125B or 125C were reloaded, 2) agent listener 134 was uninstalled, or 3) agent listener 134 is simply not running at the moment. In any of these cases, the agent is redirected to the Installer Download Page.

If the socket opens, the user is redirected to the subsequent page. Thus, the agent does not need to install anything and may proceed accordingly.

### Installer Download Processing

When the agent has gone to the Installer Download Page and finished installing, web server 120 redirects the agent back to the Installer Download Page. The agent cannot proceed to the next step without successfully passing these steps.

When the agent is redirected to the Installer Download Page, the agent may either accept the download or go back to the Login Page. When the agent accepts the download, the installer may be run. The page prompts the agent to continue when the installation has completed successfully. At this point, the process redirects the agent back to the Login Submitted Page to validate that the installation has been successful.

### Installer Processing

The installer runs as an application, not in the web browser, but in the agent's user context on the agent's system. In a thin client environment, the installer is running in a user session on a Citrix or Terminal Server environment. The installer may perform the following steps:
1) Identify if agent listener 134 is already installed.
   a. Check for the correct Java Virtual Machine version; and
   b. Check for the application components.
2) Determine if agent listener 134 is the correct version.
3) If agent listener 134 is installed but needs to be upgraded, stop agent listener 134 before upgrading.
4) When everything is finished, launch agent listener 134, even if no installation or upgrade was required.
5) Delay so agent listener 134 has time to start (possibly check for it).
6) Send information to IBM i system 115 to open a New Agent Installed Page in a POST message.
   a. The installer may need to authenticate itself using a special user to gain access to IBM i system 115 and the underlying data.
   b. One embodiment of system 100 is configured to pass the following data to the web page: MAC addresses, User ID, Hostname or IP Address, Port Number, and/or Installed Version.
7) The installer instructs the agent to click the “Next” button on their original web page and then closes.

For Citrix or Terminal Server environments, the agent may have to select the first available port from a range of ports, as all agents are actually running their agent listener 134 in the context of the same machine and/or IP address.

### New Agent Installed Page

The New Agent Installed Page is a web page that takes a Hypertext Transfer Protocol form post from the installer, not the web browser, containing the following information: MAC addresses, User ID, Hostname or IP Address, Port Number, and/or Installed Version. Web server 120 first ensures that it can open a socket to the specified host/port combination and that the User ID identifies a valid agent.

These parameters are then passed to an RPG program, which writes them into a file. The key to this file may consist of a comma separated list of MAC addresses and the User ID.

An embodiment of system 100 in a Citrix or Terminal Server environment may not support the same agent running two concurrent sessions on the same server.

Note that if the agent installs a new network adapter on their system, the agent is redirected on their next login to the installer page, since physically installing a network adapter, either by replacing an existing one or adding a new one, creates a new set of MAC addresses. The installer detects that the correct version already exists and updates the IBM i file with the new MAC address and/or User ID information. Also, having additional network interfaces running, for example by loading a wireless connection in addition to a LAN adapter, results in a redirect for the first time an agent utilizes that hardware configuration, since a new hardware configuration is detected as a new combination of MAC addresses.

In another embodiment, system 100 may need to use all MAC addresses associated with a User ID if it cannot reliably determine the relevant one from an applet context.

The installer in accordance with another embodiment of system 100 is customizable by a client so that the client can override the program to launch, for example by replacing a web browser with a rich client application. The installer may need to be able to identify whether it is running on a Citrix or Terminal Server environment, and change how it assigns port numbers accordingly.

Yet another embodiment of system 100 contemplates the need for assigning ports from a collection of available ports, possibly by obtaining that information from IBM i system 115. The installer may need to check if agent listener 134 is already installed and start it, if necessary. The installer may also need a way to find and shut down the running agent listener 134.

### Security

In one embodiment, agent listener 134 may be configured to insist on a client certificate that it can verify as coming from the client, in order to prevent denial of service attacks. In this way, system 100 effectively prevents popup web browser window requests from originating from another system, possibly from malicious software on a user's laptop connected to the local area network, behind the firewall.

The keystore passwords may be stored encrypted and decrypted by the software. This prevents unauthorized users from making changes to, exporting or viewing certificates in the keystore. All communications between web server 120 and agent listener 134 may be performed utilizing the Secure Sockets Layer protocol to protect content from unauthorized inspection. For added security, the installer page may be secured with password access, or the software may keep an audit of all downloads conducted by the combination of the User ID and originating IP address.

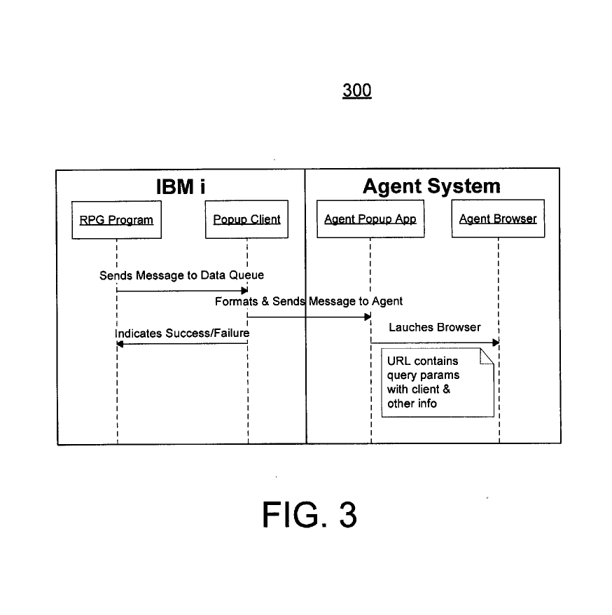

FIG. 3 is a second flow diagram 300 illustrating a sequence of steps that IBM i system 115 uses to communicate with agent listener 134. It should be noted that the steps or portions of steps may be performed in the depicted order or may be performed contemporaneously, in parallel, or in a different order.

An RPG program in IBM i system 115 formats a Uniform Resource Locator (“URL”) using the information which was sent to IBM i system 115 during the installation of agent listener 134.

The formatted URL is then sent to the agent's system, which agent listener 134 utilizes to launch a new web browser window. If the agent system is unable to launch a web browser, or if IBM i system 115 is unable to establish a connection, failure is indicated.

### Generalization

It should be obvious to anyone sufficiently versed in the art, that to implement this solution, any system comparable to IBM i system 115 may be utilized. Web server 120 that is being accessed could reside anywhere and may be hosted on any combination of operating systems and web server platforms. The Java components could be substituted with ActiveX or signed .NET components or any other client-side scripting components. The PHP code that is referenced could be replaced with ASP.NET, Ruby or any other sufficiently rich server-side web scripting language.

In one or more exemplary configurations, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and without limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, and microwave are included in the definition of medium.

Disk and disc, as used herein, include compact disc, laser disc, optical disc, digital versatile disc, floppy disk and blu-ray disc, where disks usually reproduce data magnetically, while discs reproduce data optically. Combinations of the above should also be included within the scope of computer-readable media.

While the present invention has been described in detail with regards to embodiments, it should be appreciated that various modifications and variations may be made in the present invention without departing from the scope or spirit of the invention. In this regard it is important to note that practicing the invention is not limited to the applications described hereinabove. Many other applications and/or alterations may be utilized provided that such other applications and/or alterations do not depart from the intended purpose of the present invention. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

Also, features illustrated or described as part of one embodiment can be used in another embodiment to provide yet another embodiment such that the features are not limited to the specific embodiments described above. Thus, it is intended that the present invention cover all such embodiments and variations as long as such embodiments and variations come within the scope of the appended claims and their equivalents.

What is claimed:

1. A method for accessing a host computer system, said method comprising the steps of:
utilizing a web browser in a client system to access an Initial Login Page on a host computer system;
generating a list of MAC addresses present on the client system;
transmitting the list of MAC addresses and other information gathered from the client system to the host computer system;
opening a connection from the host computer system to the client system by utilizing the information transmitted to the host computer system;
executing an agent listener on the client system;
connecting the host computer system to the client system;
transmitting information from the client system to the host computer system;
transmitting commands from the host computer system to the agent listener; and
utilizing the agent listener to open a new web browser window on the client system.

2. A system for accessing a host computer system through a web server, comprising:
means for utilizing a web browser in a client system to access an Initial Login Page on a host computer system;
means for generating a list of MAC addresses present on the client system;
means for transmitting the list of MAC addresses and other information gathered from the client system to the host computer system;
means for opening a connection from the host computer system to the client system by utilizing the information transmitted to the host computer system;
means for executing an agent listener on the client system;
means for connecting the host computer system to the client system;
means for transmitting information from the client system to the host computer system;
means for transmitting commands from the host computer system to the agent listener; and
means for utilizing the agent listener to open a new web browser window on the client system.

3. The system according to claim 2, wherein the system further comprises:
means for verifying whether a combination of the list of MAC addresses and a User ID is already stored on the host computer system;
means for redirecting the client system to an Installer Download Page if the combination of the list of MAC addresses and the User ID is not already stored on the host computer system; and
means for installing an agent listener on the client system.

4. The system according to claim 2, wherein the system further comprises:
means for verifying that the version number for an agent listener is the same as a current version number;
means for redirecting the client system to an Installer Download Page if the version number for the agent listener is not the same as the current version number; and
means for installing an updated agent listener on the client system.

5. The system according to claim 2, wherein the system further comprises:
means for redirecting the client system to an Installer Download Page if the socket to the client system cannot be opened;
means for installing an agent listener on the client system.

6. The system according to claim 2, wherein the system further comprises:
means for redirecting the client system to a rich client application in lieu of a web browser based application.

7. The system according to claim 2, wherein the system further comprises:
means for accessing the host computer system via a web server.

8. The system according to claim 2, wherein the system further comprises:
means for transmitting commands containing a formatted URL from the host computer system to the agent listener.

9. The system according to claim 8, wherein the system further comprises:
means for executing a web browser based application on the client system through the new web browser window.
